(19) United States
(12) Patent Application Publication
(10) Pub. No.: US 2024/0378685 A1
(43) Pub. Date: Nov. 14, 2024

(54) SYSTEM FOR ORGANIZING ACTIVITIES IN A TERRITORY BY MESHING STORAGE RACKS WITH VEHICLE SHARING

(71) Applicant: Patrick HURPIN, Paris (FR)

(72) Inventor: Patrick HURPIN, Paris (FR)

(21) Appl. No.: 18/688,297

(22) PCT Filed: Aug. 25, 2022
(86) PCT No.: PCT/FR2022/000075

§ 371 Date: Feb. 29, 2024

(30) Foreign Application Priority Data
Aug. 31, 2021 (FR) 2109118

(51) Int. Cl. G06Q 50/06; B60L 53/51; B60L 53/65; E04H 6/42; G06Q 50/40

(52) U.S. Cl. CPC G06Q 50/06; B60L 53/51; B60L 53/65; E04H 6/422; G06Q 50/40

(57) ABSTRACT

The subject of the invention is a method for reducing pollution resulting from various activities carried out within a territory and a system for organizing these activities for the implementation of this method.

According to the invention, the territory is equipped with a plurality of vertical storage tanks (T) for storing shared electric vehicles, which are connected together so as to form a mesh network (90) allowing transfer, inside the territory (9), subjects of various activities carried out, such as people or objects transported, digitized information, as well as an amount of energy produced or consumed for the implementation of the activity.

The invention also covers a system for organizing traffic in the territory of said subjects of activity in a way that makes it possible to cancel or, at least, reduce the pollution resulting from each of the activities, taking into account its nature.

In particular, each of the storage tanks (T) can be equipped with means of producing, from renewable energy, the electrical power necessary for the operation of the garage and the mesh network makes it possible to ensure, inside the territory, a balancing between the power produced by certain storage units and the power consumed by others for the requested activities.

The invention relates to a system for organizing activities with vehicle sharing, in a territory, and aims, in particular, to reduce certain pollution resulting, essentially, from human activities.

In recent years, we have noted a progressive warming of the earth's atmosphere causing serious climatic disturbances of which we have become aware at a global level. International conferences are therefore organized periodically in order to define the measures that should be taken, particularly in the most developed countries, to combat the consequences of climate change.

Even if there are natural causes such as variations in solar activity, we know, however, that the climate changes currently observed are due, essentially, to the increase in the concentration, in the atmosphere, of certain gases greenhouse effect caused by human activities, in particular carbon dioxide emitted by heat engines or power plants producing energy from carbon fuels, coal, oil or gas.

Indeed, even in less developed countries, populations tend to group together in very large cities which are increasingly congested and polluted by the circulation of motor vehicles with thermal engines which emit not only CO2 but also particles, fine, dangerous for health.

This is why we are now seeking to reduce pollution caused by gasoline or diesel engines by developing the use of electrically powered vehicles.

However, electric vehicles have a much lower driving range than those with combustion engines because the batteries have a limited charging capacity compared to the fuel reserves of a conventional automobile.

It is therefore necessary to create electric charging stations made available to motorists for periodic recharging of their car's batteries.

Such stations, comprising several loading points, can be placed in town, in certain parking spaces. However, such recharging places remain few in number and require the installation of power supply lines connected to the network by adequate means.

It was therefore proposed to create better equipped loading stations in town. Document WO 2015/075203, for example, describes a station of this type comprising, inside a transportable structure connected to the general distribution network, a recharging module equipped with one or more battery charging points, as well as several storage spaces for waiting vehicles and, even, a rest room for drivers waiting to reload their car.

However, such a transportable structure can only recharge one or two cars at the same time. However, the number of electric cars on the road is expected to increase considerably. It therefore seems preferable to create installations allowing a very large number of electric cars to be recharged simultaneously, particularly during parking time.

The document DE 10 2010 050848, for example, describes a storage system comprising two vertical buildings which each include several floors of storage containers and between which a vertical handling column is placed. Each container can contain two vehicles placed on pallets which are connected by sliding contacts, on the one hand to the vehicle carried and, on the other hand to the container which is itself connected to a central control block provided on the building to the controlled supply of electrical power to the assembly.

However, even when cities are equipped with relatively dense public transport networks, the far too high number of vehicles in circulation is the cause of significant pollution and also requires the development of parking spaces which occupy a large surface area or must be carried out underground.

In addition, public transport lines are often arranged in a star pattern around the center of the city and peripheral connections, between suburbs, are few in number. Too many users therefore believe that they must use their personal vehicle, for example when they do not have a means of public transport near their home, or to go to poorly served areas of the city.

To encourage the use of public transport in the city, the inventor has already proposed, in French patent No. 2,898,204, to distribute in the urban area a set of garages spaced from each other and placed close to certain stations in the transport network, in particular interchange stations, each garage being designed to keep in reserve a certain number of individual vehicles, preferably electrically powered, which are made available to users.

Thus, a person arriving in the city by public transport to make several trips, will be able to get off at a transfer station close to a garage, take charge of a shared electric vehicle to go successively to several destinations, drop off their vehicle in a stockman close to his last destination and take public transport again.

For users to agree not to use their personal vehicle and to take, instead, a vehicle made available to them at the exit of a station of the public transport network, it is, however, necessary that the travel time from the station to the vehicle storage facility is short enough and the user is assured of immediately finding an available vehicle there. Likewise, after use, the user must be able to leave their vehicle in a garage located near a network station and having a free space for immediate drop-off of the vehicle.

To do this, each storage facility must first contain a sufficient number of vehicles to correspond to the expected frequency of use by users. However, within a city, the available land area is very limited and expensive. This is why it has long been proposed to limit the parking areas required by creating vertical storage units installed in tower-shaped buildings with a reduced footprint and comprising several superimposed storage levels.

On the other hand, the storage unit must be arranged so that a picked-up vehicle is immediately replaced, at the pick-up location, by a new available vehicle and that a vehicle dropped off after use is immediately introduced and stored in a storage box to allow the deposit of a new vehicle after use.

To solve such problems, patent No. 06 01848 cited above describes a vertical garage of the Noria type described, for example, in the very old patent FR No. 664 603 and which includes a large number of storage boxes suspended from an endless link stretched between two platforms spaced apart so as to form two vertical columns, respectively ascending and descending passing in front of a handling platform placed at ground level and comprising, on one entry side, a vehicle storage location able to open onto a free storage box passing to this level and, on one exit side, a location for picking up a new available vehicle coming from a storage box brought to this level.

In addition, the storage unit is equipped with automated mechanisms allowing a vehicle deposited after use to be introduced into the entry box, to transfer it to a free storage box and, conversely, after removal of the vehicle available at the exit, to make come to the handling level with a new available vehicle to pass it into the exit box and then transfer it to the pick-up location.

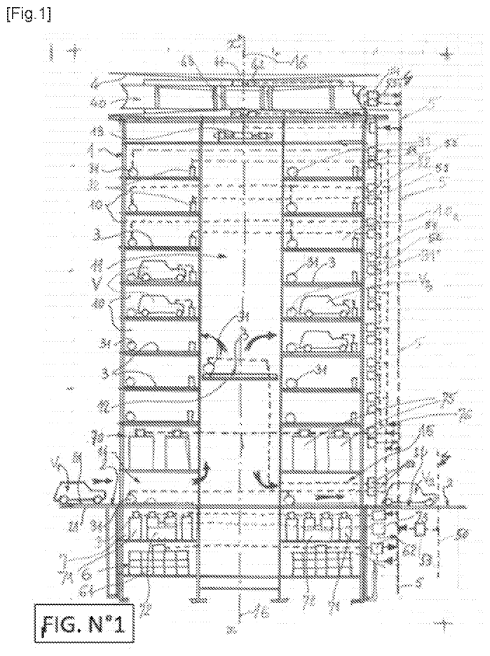

However, the mechanisms at Noria are quite bulky and it has also been imagined to carry out vehicle movements by means of vertical and horizontal movement automation in a vertical type storage unit comprising, as shown in FIG. 1 attached, two columns of storage boxes 10 arranged in several superimposed levels, inside a building 1 in the form of a tower, on either side of a central column 11 in which an automatic platform with vertical movement can move and horizontal 12 actuated by a mechanism 13.

At ground level, a handling floor 2 is provided comprising, on one side of the building 1, a location 21 for storing, after use, a vehicle V1 and, on the other side, a location 22 for taking charge of ‘an available vehicle V2.

The deposit location 21 communicates with an entrance box 14 opening onto the elevator column 11 which, on the other side, communicates with an exit box 15 opening onto the pick-up location 22.

Various mechanisms can be used to control the movements of vehicles inside the storage unit.

For example, in each of the two entry boxes 14 and exit boxes 15, as well as in the storage boxes 10, the vehicle V can be placed on a plate 3 equipped with a mechanism, symbolized at 31, for controlling the movement longitudinal, in one direction or the other, of the vehicle. And it is the same on lifting platform 2.

In this way, a vehicle V1 returned to the depot location 21 and advanced onto the plate 3 of the entry box 14 can be taken over, successively, by the corresponding longitudinal movement mechanisms 31 of the various plates 3 to pass, first, on the automatic platform with vertical and horizontal movement 12 which raises it, then, to the level of a free storage box carrying a tray 3 on which this vehicle is introduced by the longitudinal movement mechanism 31 equipping the lifting platform 12.

Conversely, after removal, by a user, of the vehicle V2 placed on the pick-up location 15, a new available vehicle is advanced onto the automatic movement platform 12 previously placed at this level and it goes back down to the handling level 2, the vehicle thus transported can then be introduced into the exit box 15 then advanced to the pick-up location 22.

Thanks to a set of such automated storage facilities distributed throughout the territory, near certain stations on the transport network, people who consider it necessary to use a car in the urban area to make several trips there will be able to leave their personal car to the storer and take public transport to get to town where they will be sure to immediately find, at the exit of a station, an available electric vehicle with which they will make their various journeys and which they will be able to drop off without wasting time, possibly in another store, near another station in the network.

The sharing system described in the prior patent therefore makes it possible to reduce the number of private vehicles circulating in the city, by replacing them with less polluting electric vehicles.

However, the number of vehicles circulating in the city does not only depend on the occasional travel needs of residents.

Indeed, because of the cost of land and operating costs, industrial or commercial companies have been led to group together in better equipped activity zones, which may be relatively far from residential areas and must, therefore, be provided large parking areas where employees' personal cars remain parked for the day. This results, at least at certain times, in significant traffic in the city, with congestion which increases pollution.

On the other hand, during a working day, the activities of a company require the circulation of numerous vehicles used for the delivery or reception of orders or for the movement of staff between various establishments.

However, the inventor realized that a set of storage units of the type described in his previous patent would make it possible to rationally organize such mobility, in order to reduce the number of vehicles in circulation.

However, the operation of such storage units, in particular for the reception, storage and exit of vehicles, as well as for the recharging of their batteries during the storage time, requires electrical power which, if supplied by the public network general, is generally produced from carbon energy, therefore polluting, or from nuclear energy. However, the inventor again realized that the use of a plurality of automated storage systems in the form of vertical towers would make it possible to distribute throughout the territory an entire production network, from renewable solar or wind energy, of a sufficient electrical power to implement a mobility organization system reducing the risks of pollution in the territory.

Moreover, automobile traffic is not the only cause of the pollution observed in the city which results, in fact, from all the activities carried out by the population and, therefore, consume energy. As a result, these activities are the origin not only of the emission of greenhouse gases, such as carbon dioxide or methane, but also of other sources of pollution such as a rise in ambient temperature.

For example, the traffic lanes necessary for activities carried out in the urban area as well as the parking areas to be created in commercial areas, which are generally asphalted, increase the absorption of solar radiation by the ground, which determines an elevation of the temperature can lead to a need for air conditioning, and therefore energy expenditure.

In addition, industrial, intellectual and commercial activities generate a mass of information which circulates, in particular, on the Internet and social networks and must be preserved and managed in increasingly large computerized data banks. Companies, but also official services, often do not have the ability to manage, internally, such a mass of information and are led to entrust their digital archives to Data Centers called “Data Centers” which are often located in foreign countries and over which clients have no real authority.

However, it appeared that automated storage systems of the type described in the previous patent, cited above, could provide a solution to this problem of information mobility.

To solve such a set of problems, the inventor therefore had the idea that by rationally using a plurality of vehicle storage systems of the type described above, it would be possible to organize the various activities carried out in a territory, in a way that makes it possible to generally reduce the pollution resulting from these activities.

The subject of the present invention is therefore a method of reducing pollution resulting from various activities carried out within a territory in which a set of shared vehicles are made available to users in a plurality of storage tanks. verticals which are distributed in the territory so as to serve areas separated from each other and each comprise at least one column of storage boxes superimposed on several levels, at least one entry location and at least one exit location, arranged on at least one handling level, automated means for picking up and moving, towards an empty storage space, a vehicle returned by a user to the entry location and automated means for supplying a vehicle stored at the exit location for pick-up by another user. In accordance with the invention, the different automated storage systems are connected together so as to form a mesh network allowing the transfer, within the territory, of the subjects of various activities carried out, such as people or objects transported, digitized information, as well as a quantity of energy produced or consumed for the implementation of the activity and the circulation in the territory of the said subjects of activities is organized in a way allowing to cancel or, at least, to reduce pollution resulting from each activity, taking into account its nature.

For the implementation of such a method, the invention therefore has as its object a system for organizing activities in which, to reduce, in particular, pollution resulting from automobile traffic in the territory, shared vehicles contained in the various automated storage tanks are of the type with electric and/or hydrogen propulsion. Furthermore, as indicated above, industrial and commercial activities are often grouped together in areas far from residential areas, which results in the daily movement of a very large number of people between their homes and the business where they work.

To solve this problem, the shared electric and/or carbon neutral vehicles contained in at least one of the storage tanks are used on behalf of at least one company located in the territory, at least to ensure the transport of certain employees from their home to the company and vice versa, the vehicle used being stored, either in one of the storage warehouses, near the company, or at the home of an employee during rest periods.

In this way, an employee of a local company, arriving by his own means to this company, without using a personal vehicle, can, after his work period, find, at the exit location of a storage located near the company, a shared vehicle made available to him by the company, then use this vehicle to return to his home, keep the vehicle at his home during the rest period and, at the end from there, take this vehicle back to go to his business and park it in the storage facility located nearby. In addition, a vehicle used for the transport of employees can advantageously be used for other reasons such as transport of people, goods or any objects, during the work period and from the storage facility where it was stored.

According to another particularly advantageous characteristic of the invention, each shared vehicle can be used for the simultaneous movement of several employees, the vehicle being parked, during rest periods, near the home of an employee furthest from the work area. activity and taking charge, first, of this employee then, successively, each of the other employees at their home to bring them to their company, the vehicle then being parked in a storage facility located near the last company served in order to ‘be free, possibly, for another use.

Furthermore, patent FR 2 898 204 cited above describes a vertical garage of the Noria type but other arrangements are possible.

In particular, each storage unit can, advantageously, be of the type comprising, inside a vertical building with several floors, a plurality of storage boxes arranged in at least one column comprising several superimposed storage levels, means automated means for controlling the vertical movement of at least one lifting platform between the handling level and each of the storage levels, and automated means for controlling the horizontal movement of a vehicle, respectively from an entry box to the platform, from the platform to a free space placed at a storage level, from a storage space to the platform, and from the platform to an exit space.

For this purpose, each of these storage units comprises an internal electrical power supply circuit to which the automated means for controlling the vertical and horizontal movements of the vehicles are connected as well as the means for recharging the batteries of the stored vehicles, for example. via connection means capable of adapting the electric current supplied by said internal electrical circuit to the characteristics of said control and recharging means.

In a particularly advantageous manner, the internal power supply circuit of each of the automated garages is connected, on the one hand, to a general electrical power distribution network, via a delivery station and, on the other hand, to additional means of producing sufficient electrical power to ensure autonomous operation of the storer, at least for some of the requested activities.

In a preferred embodiment, the additional means of producing electrical power operate from renewable energy captured at the upper part of each automated store and are connected to the internal electrical circuit of the store via a station for transforming the power supplied by renewable energy into an electric current with characteristics adapted to the various functions to be provided for the requested activities.

These additional means of producing electrical power can consist of a wind generator for capturing wind energy with a vertical axis or a set of photovoltaic panels for capturing solar energy, which are mounted on a terrace, at the upper part of the storage rack.

Advantageously, this wind generator comprises a turbine mounted to rotate around a vertical axis for capturing wind energy and placed below a set of photovoltaic panels In a preferred embodiment, the system also includes a computer data center which is arranged on at least one level of the building, in order to accommodate in the storage structure at least one network of computers, servers, storage spaces data storage and all equipment constituting the computer system of at least one company and that said data center is connected to the internal electrical circuit by connection means providing electrical power adapted to the implementation of each of the functions provided by the data center, in particular reception, archiving and sending to other sites of digitized information contained in storage spaces.

According to another preferential characteristic of the invention, the additional means of producing electrical power comprise a plurality of new or second-life batteries which form a set of power reserves stored in at least one stationary battery chamber provided on at least one level of the building and electrically connected to a delivery station connected to the internal electrical circuit of the garage via means of transforming the power supplied by all of said batteries into a current having characteristics adapted to the necessary power to ensure the various functions of the garage, respectively, the reception and delivery of vehicles stored in the building, the recharging of their batteries and the operational security of the computer data center.

In addition, when the storage store is equipped with means of producing, from renewable energy, an electrical power which is transmitted to the internal electrical circuit, at least part of this power is applied to the batteries stored in the stationary battery room to be placed in reserve during periods when said power produced by renewable energy exceeds the needs of the storer for the operation of the activities requested from it.

In another embodiment of the invention, the additional means for producing electrical power can also consist of a station for producing electricity from hydrogen placed on a stage of the store and comprising means for generating electricity. hydrogen by hydrolysis and means of production, from the quantity of hydrogen thus supplied, of additional electrical power which is injected into the internal electrical power supply circuit of the storer.

According to another particularly advantageous characteristic of the invention, the internal electrical circuits of all the storage units distributed in a mesh network in the territory, are connected to the same general distribution network which ensures power balancing between, On the one hand, the electrical powers produced in each of the storage units by the additional means of production or the stationary batteries and, on the other hand, the powers consumed by each of the activities carried out.

It should be noted, on the other hand, that the territory in which the automated storage systems are distributed can be that of a large conurbation such as an urban metropolis or that of a region or even a group of countries grouped together for certain activities.

But the invention will be better understood by the detailed description of certain embodiments and certain applications, with reference to the appended drawings.

FIG. 1 is a view, in vertical section, of an automated storer for implementing the invention.

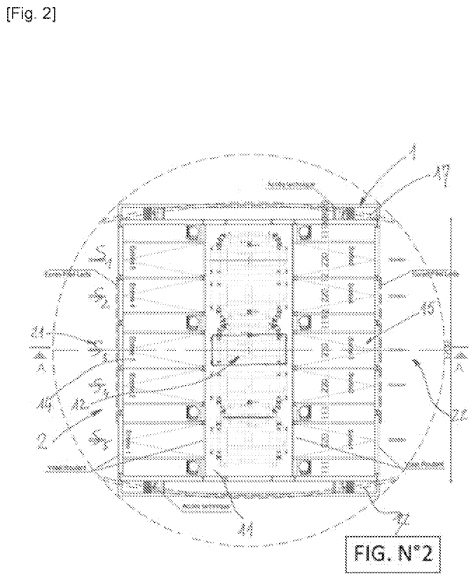

FIG. 2 is a cross-sectional view of the storage unit, at the entry and exit level of the vehicles.

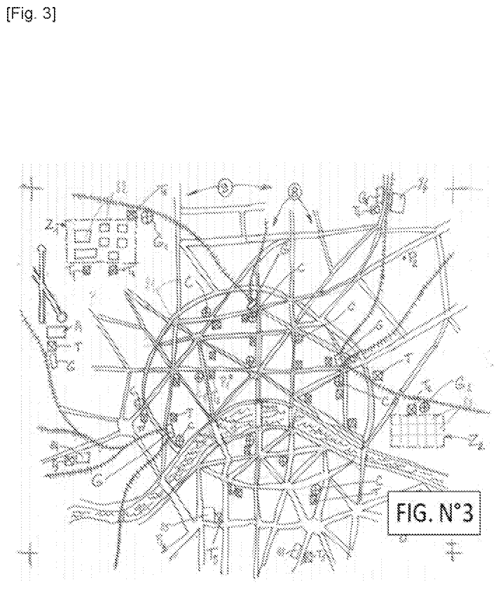

FIG. 3 is a diagram showing an urban territory equipped with a set of storage tanks for the implementation of the invention.

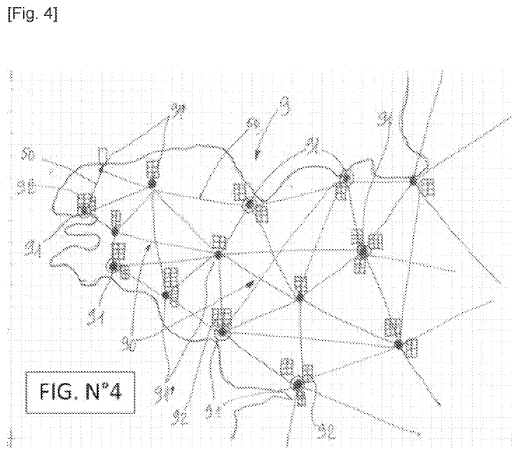

FIG. 4 schematically shows a region equipped with a mesh network of storage units according to the invention.

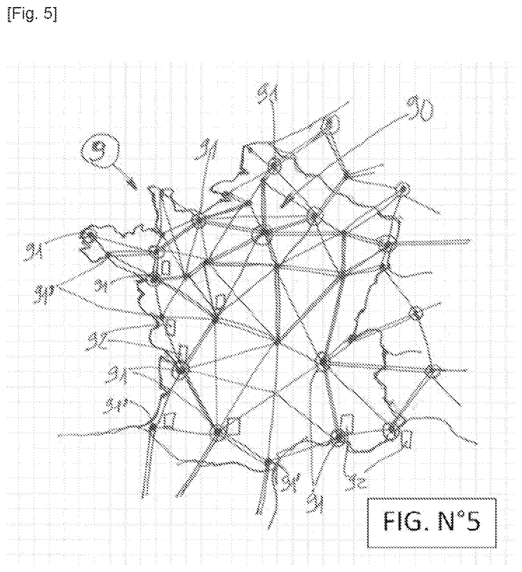

FIG. 5 is a diagram of the national territory to which this region belongs.

As indicated above, FIG. 1 shows, in vertical section, a type of vertical storage store used for the implementation of the invention and comprising, inside a vertical building 1 in tower shape, columns of storage boxes 10 arranged on several superimposed floors, on either side of a central column 11 in which the lifting platform 12 of an elevator actuated by a mechanism 13 can move.

Such a building can have, for example, around ten storage levels, which corresponds to the height of a building of 6 to 8 floors. However, the base of the garage can be more or less buried in the ground, which makes it possible to adapt the height above ground to the environment, to town planning regulations and building rights, by reducing it in areas with protect.

In addition, as we will see later, certain floors can be reserved for specific activities. Furthermore, FIG. 1 shows the central part of a building which can, therefore, contain around fifteen vehicles stored in two columns, on either side of the central elevator column 11. To increase the storage capacity of the storer, this can, therefore, be constituted, in the manner shown in cross section in FIG. 2, of several adjoining sections S1, S2 . . . S5 each comprising, a lifting platform 12 moving in a central column 11 to serve, at its ends, two columns of superimposed storage boxes 10 each having, at a handling level 2, respectively, an entry box 14 and an exit box 15 of the vehicles which open respectively, on one side onto a location 21 for depositing a returned vehicle V1 and the other, on a location 22 for picking up an available vehicle V2.

Each storage box 10, as well as the lifting platform 12, carries a plate 3 on which the stored vehicle V rests and each plate 3 is equipped with a mechanism 31, for example screw or jack, making it possible to control the translation longitudinal of the vehicle, to move from one space to the elevator or vice versa.

Thus, after using a car V1, it can be returned to the deposit location 21 and then introduced into the entry box 14, either immediately by its driver, or by a suitable mechanism, or by an operator attached to the storer who checks the condition of the car. The lifting platform 12 is then brought to handling level 2 and receives the car V1 pushed by the translation mechanism 31 of the entrance box 14.

The automatic platform with vertical and horizontal movement 12 is then raised to the floor of an empty space, for example 10a, into which the returned car A can be pushed back by the translation mechanism 31 of the platform 12.

For a good understanding of the system, it is noted that the new offer of the proposed system is not an ERP (Etablissement Recevant du Public), the users do not enter the storage facility and only receive the V1 vehicles at the entrances and exits. to use them outside the storage unit(s). The user does not park the vehicle V1 on the platforms 3.

Conversely, after removal of an available car V2 placed in advance on the pick-up location 22, the platform 12 is brought to the level of a new car, for example V3, which is pushed back onto the platform 12 by the corresponding translation mechanism 31′.

The platform 12 then descends to the handling level 2 and the car V3 is then pushed back by the corresponding translation mechanisms 31, first into the exit box 15, then onto the pick-up location 22 to be placed at the available to a future user.

On the other hand, as indicated in the previous patent FR 2 898 204, each of the storage compartments 10 is equipped with means 32 for recharging the vehicle's batteries during the storage time in the storer. These means 32, represented symbolically in FIG. 1, include, for example, a Wallbox type charging terminal (registered trademark) which automatically connects when the car comes to rest on the plate 3 of the storage box.

At each storage stage, these Wallbox (registered trademark) terminals 32 are electrically connected to the internal power supply circuit 5 by connection means 51. Likewise, the automatic control mechanism 13 with vertical and horizontal (elevator) movement 12 and the vehicle translation mechanisms 31 are actuated by automated control means 52 electrically connected to the internal power supply circuit 5. And it The same applies to the translation mechanisms 31 equipping the entry box 14 and the exit box 15, at handling level 2.

Of course, these connection means 51 and control means 52 are capable of adapting the electric current supplied by circuit 5 to their characteristics and can include, for example, differential switches associated with a circuit breaker and a current emission trigger.

Conventionally, the internal power supply circuit 5 of each of the automated storage units is itself connected, via a delivery station 53, to a general network 50 for distributing electrical power throughout. of the territory.

However, according to one of the essential characteristics of the invention, each of the storage units (garages) can also be equipped with additional means of producing sufficient electrical power to ensure autonomous operation of the storage unit, at least for some of the requested activities, without using the general distribution network 50.

Such additional means of production can be of different types.

First of all, as the storage units are in the form of towers standing vertically on a variable height which can be chosen depending on the environment, regulations, building rights, environmental constraints, they are particularly suited to using the renewable energies coming from the sun and wind by means of collection connected to the internal electrical circuit 5 via a station for transforming the power supplied by renewable energy into a current of characteristics adapted to the various functions to be ensured for the activities requested.

Thus, in the embodiment shown, by way of example, in FIG. 1, the upper platform of the storage building, 1 carries a set of photovoltaic panels 4 which capture solar energy. These panels can cover a large surface area, for example 430 m2 and are connected to a voltage regulator 41 and an inverter 42 providing electrical power which is transmitted to the internal electrical circuit 5 by transformation means 54 comprising a green meter and a circuit breaker alternating current in order to adapt the power supplied, in direct current, by solar energy to the voltage of circuit 5.

On the other hand, the storer can also be equipped with a wind generator 40 such as a wind turbine placed below the solar panels 4 and rotatably mounted around the vertical axis 16 of the tower 1.

This wind generator 40 drives an alternator which supplies either alternating or direct current, the voltage of which is adapted by a voltage regulator 43 and transmitted to the internal electrical circuit 5 by transformation means 55.

Furthermore, due to the fact that the storage units distributed throughout the territory are made up of vertical towers comprising several floors of shared electric vehicle storage spaces, it is possible to reserve certain floors for other applications.

For example, in the embodiment shown in FIG. 1, the storage building 1 comprises, in the basement, a floor 6 comprising a stationary battery room and a floor 7 comprising a mini-station. production of electricity from hydrogen.

The stationary battery chamber 6 makes it possible to store a large number of batteries 61, in particular used batteries from electric cars which must be replaced when their power is reduced to 70% and, possibly replaced by new batteries. The assembly thus makes it possible to store energy in order to provide the storer with another additional power which can be added to the power supplied by renewable energy.

For this purpose, these batteries 61 are connected to the internal electrical circuit 5 via connection means 62 allowing either to inject additional power into the circuit 5 in order to implement the various activities of the storer or, Conversely, to provide, from circuit 5, the power necessary for recharging the batteries 61 stored in chamber 6. Via the internal circuit 5, it is thus possible, when the additional power supplied, from renewable energy, by the production means 4, 40, exceeds, at a given moment, the needs of the storer for the implementation of the activities requested at this moment, to store and keep in reserve the excess part of this power in the stationary battery chamber 6, for later use or, as we will see later, to provide additional power to other storage units distributed throughout the territory.

Furthermore, another stage 7 of the store can be equipped with a micro-station for producing electricity by hydrogen, comprising hydrogen generators by hydrolysis 71, supplied with current by the internal circuit 5, and production means 72, from the hydrogen thus supplied, an additional power which is injected, into the internal circuit 5, by a delivery station 73 arranged so as to be able to also supply the generators 71, from the internal circuit 5, the energy needed to produce hydrogen.

As indicated above, the vertical storage units previously described in French patent No. 06 01848, were intended to reduce part of the automobile traffic in the city, by allowing people needing a car to carry out transportation there. various trips, to leave their personal car at the storager and to take public transport, these people being assured of finding, at the desired location, a shared electric car, made available to them at the exit of a storage placed close to certain transport network stations and railway stations.

However, the pollution caused by automobile traffic also results, in large part, from the daily travel of people between their home and their place of work where it is also necessary to provide large parking spaces where employees' cars remain parked all day. the day.

As an example, FIG. 3 is a diagram of a major city 8 whose center is equipped with a public transport network (not shown) with a number of stations C placed, generally, near the main roads 81. According to the provisions of prior patent FR 06 01 848, cited above, numerous garages T for storing shared electric vehicles are distributed throughout the urban area, in particular in the center, at proximity of certain C stations of the transport network and G stations of the railway lines serving the city or, where appropriate, in an airfield quite far from the center, near terminal A.

As indicated above, many industrial, tertiary or commercial companies are often grouped together in activity zones more or less distant from the residential areas where most of the homes are located, such as the center of the urban area, more pleasant areas, or areas where collective buildings are grouped together.

As an example, the diagram in FIG. 2 shows a zone Z1 comprising workshops and offices 82 of a large industrial company and a zone Z2 grouping together the premises 83 of a certain number of small or medium-sized businesses. Near the Z1 zone or within it, one or more T1 storage units have been installed in which a number of vehicles can be stored in relation to the size of the company's workforce. Likewise, the Z2 zone bringing together several companies or businesses, is equipped with one or more T2 storage units providing a quantity of vehicle storage spaces in relation to the number of people working in this zone.

If the company's Z1 zone, or Z2 zone, is located near a G1, G2 station of the public transport network, employees with access to this network can use it to come to work but the trains are often overloaded at certain times, which leads some people to use their personal cars.

The invention makes it possible to resolve this drawback and, thus, to reduce pollution resulting from transport.

Indeed, an employee living, for example, in P1 in the center of the city can use the transport network once, from a C1 station located near his home, to go to a G1 station, G2 serving zone Z1 or Z2. However, instead of taking public transport to return home at the end of the day, he can take charge of a shared electric car, at the exit of one of the garages T1, T2 neighboring Zone Z1, Z2 or, even, placed inside it and he uses this car to return to his home. He then leaves the car at the entrance to a T3 storage warehouse (garage) placed, for example, near the C1 station close to his home where he spends the night. The next day, he can take an available car at the exit of the neighboring storage facility T3 (different from the one he had dropped off the day before) to go to zone Z1, Z2, of his company where he can drop off the car in the one of the T1, T2 garages located nearby. At the end of his working day, the same employee returns to the storage facility to pick up a new shared car which he will drop off at the T3 garage, near his home.

In the suburbs far from the city center, land is less expensive and it is possible to create 84 car parks near the G4 stations of the regional transport network, each of which is equipped with a T4 storage unit for storing electric vehicles. shared.

Likewise, it is possible to build a certain number of T5 storage units for shared electric vehicle storage, in regions far from the center and not served by public transport, each T5 storage unit being close to an 85 parking space.

Thus, an employee living, for example, in P2 in a region where there is a G4 station of the regional network, will be able to go to this location with his personal car to park it in parking lot 84 and, instead of taking a regional transport train, he will be able to find at the T4 storage facility a shared vehicle which he will drop off in a T1, T2 storage facility in the Z1, Z2 activity zone where he will find, at the end of his working day, another shared vehicle to return to garage T4 and take your personal car in parking lot 84 to return home.

Likewise, an employee living in P3, in a suburban area far from any station, will be able to go, with his car, on two wheels or on foot, to the storage facility T5 to leave his car in the neighboring car park 85 and pick up, at the exit of garage T5, a shared electric vehicle with which he will go to work, by depositing it in the storage T1, T2 close to the activity zone Z1, Z2 where he works. At the end of the day, he will take another shared vehicle which he will drop off at the T5 storage facility to take his car and return home.

Furthermore, the same shared vehicle can transport several people to the same activity area or neighboring areas. Thus, several people working in the same activity zone Z1, Z2, will be able to agree so that the person living furthest away takes a shared car from the storage facility T3 close to their home, then adapts their route to successively take the others people; drive them to work and bring them home at the end of the day, saving the shared car for the next day.

Thanks to the invention, regardless of where they live, each employee working in an industrial or commercial company in the area will therefore have the possibility of using a shared vehicle made available to them in a nearby storage facility. their home, instead of using public transport or their personal car, which helps reduce car traffic and the load on the transport network.

It should be noted that storage tanks and shared vehicles could be financed by the territorial administration which will find an advantage in reducing car traffic and reducing the number of users of the transport network, in particular in rush hours.

Likewise, companies will have an interest in building storage units in their premises in order to provide their employees with shared electric cars because they will not have to create large parking spaces for their staff, nor pay subsidies. to transportation. In return, employees will save significantly on their transportation costs, which will increase their purchasing power.

Furthermore, shared vehicles can also be used by customers or other people connected to the company, who can come there with a shared vehicle picked up in a storage facility located, for example near a railway station. iron G or terminal A, or, if they come by car, from a storage facility next to a car park and located in an easily accessible suburb.

The invention therefore makes it possible to reduce the overall pollution resulting from the mobility of people between their home and their place of work and, in general, of all people in connection with the activities carried out in industrial or commercial zones.

On the other hand, vehicles parked upon arrival by employees, in a storage facility located near the activity area of a company, may be used by the company, during the day, for transport, the delivery or supply of goods or other objects, stored vehicles can thus be used, in particular, for micro-freight, by making it possible to resolve the so-called “last mile” transport problem.

In this regard, in addition to not producing greenhouse gases, the electric vehicles used in the invention also have the advantage of circulating silently, which allows a reduction in noise pollution and, possibly, a night traffic of utility vehicles.

This activity of electric vehicles circulating, as in a mesh network, between the storage units (garages) and the different zones of the territory, evokes that of bees flying from one flower to another in a garden, the storage units being able, then, be considered as hives.

It should also be noted that, at the end of the working day, there must remain sufficient vehicles in the storage facility for employees to return home. It is, therefore, advantageous that the total number of vehicles stored in a storage facility is greater than that necessary for employees' home-to-work transportation, which, moreover, can vary from one day to the next.

In addition, the vehicles stored are not necessarily identical and certain storage spaces may have different dimensions and arrangements, suitable, for example, for the storage of utility vehicles.

Likewise, the means of travel and the means of storage of vehicles can be adapted to other means of individual transport such as bicycles, motorcycles, electric scooters.

Furthermore, the vertical vehicle storage systems according to the invention can have other uses making it possible to reduce not only greenhouse gas emissions but also, through a network, to facilitate mobility of all kinds. in the territory and, at the same time, to generally reduce pollution resulting from the various activities carried out by the population.

In particular, a vertical store of this type used for the storage of shared electric vehicles can also include, on a floor 70, a computer data center making it possible to host at least one network of computers, servers, storage spaces data and all equipment making up the computer system of at least one large company or a very large number of small companies. These elements can be recorded in containers 75 housed on the floor 70 of the storer and storing in memory the digitized data corresponding, for some, to the activities of a very large company and, for others, those of several thousand small and medium-sized businesses.

All these containers 75 receive the energy necessary for their operation from the internal circuit 5 and the general network 50, via a transformation station 76.

This transformation station can also be arranged to be able to send the information to be stored to the data center or, conversely, send this information back to the data centers of other storage units via the general network. 50.

Generally speaking, however, the different storage units can be connected to telecommunications networks of all types allowing, on the one hand, the introduction into the data center of digital information to be stored and, on the other hand, the exchange of information between the data centers of the different stores.

Such a data center, in English “Data Center Edge”, has the advantage of being located close to and under the control of the company that supplies it, called “the sovereign data”.

Currently, in fact, companies generate more and more computerized data necessary for their operation, more numerous day by day, and these must be stored and memorized in such a way as to remain immediately accessible and possibly consultable by other entities. These storage needs are increasing more and more and companies are required to entrust their data to a network of accessible services with considerable means of storing and querying data. Such an international service called “Cloud” is completely independent of its customers who have no real control over the use of their data and there is a risk of momentary stopping of the transmission of information and, even, misappropriation of these.

However, the invention makes it possible to provide a solution to this problem.

Indeed, a large company with, in its territory, one or more vehicle storage systems intended for transporting its employees, could establish, in one or more of its storage facilities, data centers large enough to store and use the data. all the data corresponding to its activities, thus creating a sovereign Data Center, without calling on an external service over which it would have no real authority.

In addition, other entities, customers or suppliers of this company could also be equipped with storage units according to the invention, comprising a data center and all these vehicle storage units, originally intended to facilitate “decarbonized” travel.» people, can be linked together by a mesh telecommunications network allowing an exchange of information between all the actors in the system.

Likewise, the T2 storage warehouses serving commercial areas such as Z2 bringing together a certain number of small and medium-sized businesses could include, on one or more floors, Data centers for storing the data of all these businesses which could, moreover, accommodate data from companies located in other locations in the territory, outside the Z2 zone. Indeed, a storage tower can have, for example, a width of 15 to 20 m and each floor has sufficient surface area to house a data center capable of accommodating the data of several thousand small businesses. Furthermore, as described above, each vehicle storage unit can be equipped with additional means 4, 40 for producing electrical power from renewable energy, or else, on a floor 6, a chamber of recycled batteries 60 which can, on the one hand, provide a quantity of energy allowing the storer to operate autonomously and, on the other hand, absorb and accumulate a quantity of power, each storer being able, thus, constitute a micro-point of energy storage allowing, for example, to put in reserve, in very sunny or windy periods, a part of the renewable energy produced and exceeding the energy needs of the storer to ensure the activities required for this moment and, conversely, to provide the general network with additional power allowing certain garages in the area to meet temporary needs linked to the activities requested at that location and exceeding their own capacity at that time.

Indeed, according to another important characteristic of the invention, the “hives” constituting storage tanks (garages) for storing vehicles distributed throughout the territory can be connected to each other via the general distribution network 50, as well as by one or more telecommunications networks, the whole constituting a mesh network of storage units covering, in a capillary manner, a large territory.

By way of example, FIG. 4 schematically shows a region 9 comprising a certain number of large cities or metropolises 91 and medium or small towns 91′ which are each equipped with a set of storage tanks. vehicle storage 92 operating in the manner just described, referring to the diagram in FIG. 3.

These cities 91, 91′, are supplied with electrical power by the general distribution network 50, by means of wire lines supplied, depending on the location, with very high, high or medium voltage. In addition, all cities are also connected in different ways, notably by non-wired telecommunications networks, for example 4G mobile telephony and, now, 5G, as well as, of course, by the road and rail transport network. The assembly therefore forms a capillary mesh network 90 which extends over the entire region 9, as well as neighboring regions.

Thanks to all of the electric vehicle storage units according to the invention, which are distributed over its territory in the manner shown in FIG. 3, each of these cities 91, 91′ constitutes both a production zone, storage or consumption of energy which may, depending on all the activities carried out at each moment, need power supplied by the general network 50, or produce excess energy, for example when the place is very sunny, and thus be able to provide the necessary power, via the general distribution network 50, to other cities whose local production, at the level of their storage units 92, is insufficient to carry out the activities requested at that moment, the general network 50 ensuring, in a known manner, the balancing of the powers produced and consumed.

Such a system of organizing the distribution of power produced and consumed in the territory therefore makes it possible to better use renewable energies, solar or wind, which can be captured in the territory, by compensating for the fact that these energies are intermittent and irregularly distributed and that, moreover, these renewable energies cannot be stored and put in reserve.

Thanks to the invention, on the contrary, if the power produced, at a store, by the wind or the sun exceeds the needs resulting from the activities carried out at that moment, it can, not only, be put in reserve in the stationary battery chamber of the storage tanks but also be used for the operation of storage tanks located in other cities and which cannot, at that moment, operate autonomously.

It should also be noted that, in a region such as, for example, Brittany in France, which is far from the main electricity production plants, in particular by nuclear energy, the system according to the invention would, in the event of risk of “black out” (global outage) due to excessive consumption, to avoid using the general public network, with the costs and losses resulting from the transmission of power over long distances. As we have just seen, in fact, excessive consumption in a city could be compensated by the power produced by storage units located in cities with better sun or wind at that time.

On the other hand, as shown in FIG. 5, the mesh network, according to the invention, of vehicle storage units, can extend over the entire national territory comprising metropolises 91 and a set of cities medium 91′ equipped, depending on their importance, with a greater or lesser number of storage units 92 for storing vehicles according to the invention which are interconnected by the general electricity distribution network 50, by a road network and railway not shown, as well as by one or more telecommunications networks, the storage units 92 distributed throughout the territory constituting, according to the invention, a system for organizing the various activities carried out by the population, the circulation of people and goods and the exchange of information stored in data centers set up in the storage facilities, in a way that makes it possible to generally reduce the various pollution resulting from these activities.

It should be noted, moreover, that the mesh network 90 installed in the national territory 9 could be extended in neighboring countries which can also be equipped with vehicle storage according to the invention, which would allow, in particular, to facilitate the cross-border movement of people working abroad who can thus benefit from shared electric cars, in the manner described above.

The present invention is obviously not limited to the details of the embodiments and applications which have been described by way of example but covers all the variants remaining within the scope of the claims.

For example, we have described and shown in FIGS. 1 and 2, a vertical storage rack for vehicles of the automatic type with vertical and horizontal movement, comprising several adjoining sections each comprising two columns of superimposed storage boxes, on either side of an automatic column with central vertical and horizontal movement but other arrangements would be possible, for example a Noria type storer as described in the previous patent FR 06 01848, the floors arranged as a data center, stationary battery room or for hydrogen production, which can be arranged in the foundations or in the upper part of the building.

Furthermore, each storage unit (garage) of the automaton type with vertical and horizontal movement shown in FIG. 2, has a square or rectangular section and its lateral sides can, advantageously, be covered with rectangular panels, possibly curved 17, which extend over the entire height of the building 1. However, these very large rectangular facades standing vertically at different points of the territory constitute kinds of totems which can have an informative role of royal organization and of emergency (LED screens) each panel 17 being provided with digital means of displaying images or messages, either citizen messages, or informative messages, or emanate from all types of administrations allowing access to new information.

We could, therefore, use these panels to inform the population, for example of the weather, the environmental situation such as air quality or the level of nuisances, for example noise, and to give advice on how to remedy them.

It should also be noted that each storage unit (garage) is equipped with means of recovery and storage of rainwater, then filtered, this stored water can feed the partially vegetated facades of the storage unit, the water sprayed by misting then allows on proximity zones to reduce the effects of ambient over-temperature of “Urban Heat Islands” (ICU) by a few degrees of temperature.*

In this regard, according to an advantageous arrangement of the invention, it makes it possible to partially green these vertical walls, according to a recent technique called hydroponics, in order to create in different places in the city, real green walls capable of filtering, ‘humidify and refresh the ambient air, while also improving the biodiversity aspect of cities that are often too mineral devoid of green spaces in the middle part (ground floor+3 levels) and upper part of the city (3rd level up to 8th level).
An observation made possible thanks to constant monitoring of air quality. To measure this, several pollutants having different sources are taken into account and which are distinguished into two types. Primary pollutants, such as particles and nitrogen dioxide, mainly come from sources of pollution such as road traffic, industries, heating or even agriculture, and secondary pollutants, such as ozone, which come from reactions chemicals between several gases between them. Particles and nitrogen dioxide can be both primary and secondary pollutants, such as nitrogen dioxide which comes from 50% of road traffic
According to the World Health Organization (WHO), in 2012 6.5 million deaths were associated with air pollution worldwide, and in France, a study by the public health agency denounces particles fine, responsible for 48,000 deaths per year, the equivalent of 9% of the country's mortality, with a concentration of harmful effects in the cities for the citizens who reside there.

Thus, the storage tanks (garages) for storing vehicles according to the invention could still, through their side walls, participate in the fight against pollution by reducing emissions of pollutants such as PMC10, dioxides, particles, secondary pollutants in cities. Through the unitary effects of their establishments, storage operators can provide responses to current environmental concerns through new uses without recreating specific infrastructures for each problem encountered.

The storage tanks thus proposed described by all the figures and texts above allow the creation of new industrial infrastructures providing a response to the overall pollution of cities, allowing an ecological transition by offering a replacement for current overly polluting vehicles which will not be more accepted to ride in cities in general, (Crit'air) allowing the possibility of a gradual transition from a unitary “Storage” system alone but also in territorial mesh producing an all-in-one network system opening actions news on the organization of cities but also networks of cities among themselves in the territories. The proposed offer of these storage units makes it possible to deal with carbon-free mobility, energy capture (ENr), sovereign data, information, the provision of urban freshness islands (IFU), the treatment offer of bio diversity in urban centers.

1. System for organizing activities within a territory in which a set of shared vehicles (V) of the electric propulsion type are made available to users in a plurality of storage units (T) distributed in the territory so as to serve areas separated from each other and each include, inside a vertical building (1), at least one column of storage boxes (10) superimposed on several levels and each equipped with, means (32) for recharging the batteries of the stored vehicle, at least one entry location (21) and at least one exit location (22), arranged on at least one handling level (2), automated means for picking up and moving to an empty storage space of a vehicle returned by a user on the entry location (21) and automated means for bringing a vehicle stored on the exit location (22) for its handling by another user, said automated control means (31) as well as the means (32) for recharging the batteries being electrically connected to an internal circuit (5) for supplying electrical power which is connected itself to a general distribution network (50), characterized in that each of the vehicle storage units (T) is equipped with additional means of producing electrical power capable of ensuring autonomous operation of the storage unit (T) at least for some of the requested activities and that the different automated storage systems (T) distributed in the territory are connected together so as to form a mesh network allowing the transfer, within the territory, of the subjects of various activities carried out, such as people or objects transported, digitized information, as well as a quantity of energy produced or consumed for the implementation of the activity, the circulation, in said mesh network, of said activity subjects being organized in a manner making it possible to cancel or, at least, reduce the pollution resulting from each activity, taking into account its nature.

2. System for organizing activities according to claim 1, characterized in that the additional means (4, 40) for producing electrical power operate from renewable energy captured at the upper part of each garage of storage and are connected to the internal electrical circuit (5) of the garage via a transformation station (54, 55) of the power supplied by renewable energy into an electric current with characteristics adapted to the various functions to be ensured for the activities requested.

3. System for organizing activities according to claim 2, characterized in that the additional means of producing electrical power comprise a set (4) of photovoltaic panels for capturing solar energy, mounted on a platform, at the upper part of the building (1) of the garage (T).

4. System for organizing activities according to claim 2, characterized in that the additional means of producing electrical power comprise a wind generator (40) for capturing wind energy, mounted in the upper part of the building of the storer (1).

5. System for organizing activities according to claims 3 and 4, characterized in that the set of photovoltaic panels (4) is arranged above a wind generator (40) rotating around a vertical axis for collection wind energy.

6. System for organizing activities according to claim 2, characterized in that the additional means for producing electrical power comprise a plurality of power storage batteries placed in a stationary battery chamber (6) provided on one floor of the storage building (1).

7. System for organizing activities according to claim 6, characterized in that the stationary battery chamber (60) makes it possible to store a large number of batteries (61), in particular used batteries from electric cars which must be replaced when their power is reduced.

8. System for organizing activities according to claim 7, characterized in that the batteries (60) stored in the stationary battery chamber (6) can, on the one hand, provide the storer (T) with a quantity of energy allowing the store to operate autonomously, at least for certain activities and, on the other hand, to absorb and accumulate a quantity of power.

9. System for organizing activities according to claim 8, characterized in that thanks to the quantity of energy absorbed by the stationary batteries (6), each storage unit (T) can constitute a storage and reserve point, in very sunny or windy periods, on the one hand of the renewable energy produced and exceeding the energy needs of the storer (T) to ensure the activities requested at that time and to provide the general distribution network (50) with additional power allowing certain storekeepers in the territory to meet temporary needs linked to the activities requested at this location and exceeding their own capacity at that time.

10. System for organizing activities according to claim 9, characterized in that all of the storage units (T) connected together by the distribution network (50) constitute a mesh network covering the territory in a capillary manner.

11. System for organizing activities according to claim 10, characterized in that the territory covered by the mesh network is a region comprising a certain number of towns (91, 91′) each equipped with a set of storage units (T) storage of shared vehicles and supplied with power by the general distribution network (50), which each constitute an energy production, storage or consumption zone, the general network (50) ensuring the balancing of the powers produced or consumed.

12. System for organizing activities according to one of the preceding claims, characterized in that a vehicle storage unit (T) can be equipped with a station for producing electrical power by hydrogen comprising means (71) for generating hydrogen connected to the internal electrical current supply circuit (5) and means (72) for producing, from the hydrogen thus supplied, additional electrical power which is injected into the circuit internal (5) by a delivery station (73), the latter being arranged so as to be able to supply the energy necessary to the generators (71), from the internal circuit (5).

13. System for organizing activities according to one of the preceding claims, characterized in that the territory served is an urban area comprising at least one activity zone (Z1) in which at least one industrial or commercial enterprise is located having employees domiciled in remote residential areas, said activity zone (Z1) is equipped with at least one automated storage unit (T1) capable of containing a number of vehicles in relation to the size of the company's workforce and said vehicles are made available to employees in such a way that an employee can take charge of a shared vehicle in the storage facility (T1) adjacent to the company's activity zone (Z1) to return home, drop off the vehicle at the entrance of a storage facility (T3) close to his home where he spends the night and take, the next day, a vehicle available in the nearby storage facility (T3) to go to the activity zone (Z1) where he can drop off the vehicle in a storage facility in the company's activity zone (Z1).

14. System for organizing activities according to claim 13, characterized in that an employee living in an area not served by public transport and equipped with a T5 storage unit close to a car park 85, can go with his personal car to the T5 storage facility to drop off his car in the nearby parking lot 85 and take, at the exit of the T5 storage facility, a shared vehicle which he will drop off in the T1 storage facility near the Z1 activity zone where he works and where, at the end of the day, he will find another shared vehicle which he will drop off at the T5 storage facility to pick up his car and return home.

15. System for organizing activities according to one of claims 13 and 14, characterized in that a vehicle having been used for the transport of an employee and placed in a storage unit (T1) of the activity zone (Z1) of the company can be used for other reasons such as transport of people, goods or any objects, during the work period and from the store where it was stored.

16. System for organizing activities according to one of claims 13 to 15, characterized in that the same shared vehicle can be used for the joint travel of several people working in the same activity zone (Z1) and being able to agree so that the person living furthest away takes a shared car parked near their home and then adapts their route to successively pick up each of the other people at their home to take them to their business and bring them back to their home in end of the day by saving the shared car for the next day.

17. System for organizing activities according to one of the preceding claims, characterized in that a computer data center (75) is arranged on at least one level (70) of the building (1), in order to host in the storage structure at least one computer network, servers, data storage spaces and all equipment constituting the computer system of at least one company and that said data center (75) is connected to the internal electrical circuit (5) by connection means (76) providing electrical power adapted to the implementation of each of the functions provided by the data center (75), in particular reception, archiving and sending to other sites of digitized information contained in the storage spaces (75).

18. System for organizing activities according to claim 17, characterized in that several storage units (T) distributed throughout the territory and each equipped with a data center (75), are connected by a mesh telecommunications network allowing, on the one hand, the introduction, into a data center (75), of digital information to be stored and, on the other hand, the exchange of information between the data centers of the different stores.

19. System for organizing activities according to one of the preceding claims, characterized in that, each storer being placed in a building (1) limited by large vertical walls standing vertically in different locations, certain walls can be planted and supplied with collected and stored rainwater, so as to create green walls capable of filtering, humidifying and refreshing the ambient air.
